(19) United States
(12) Patent Application Publication
(10) Pub. No.: US 2006/0264549 A1
(43) Pub. Date: Nov. 23, 2006

(54) Flame retardant compositions for building panels

(76) Inventor: Loic Pierre Rolland, Divonne les Bains (FR)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/431,683

(22) Filed: May 10, 2006

Related U.S. Application Data
(60) Provisional application No. 60/682,288, filed on May 18, 2005.

(51) Int. Cl. C08K 3/26

(52) U.S. Cl. 524/425; 524/556; 524/563; 524/449; 524/445

(57) ABSTRACT

A flame retardant comprises from 15 to 50 wt % of one or more ethylene including EVA, ethylene alkyl acrylate, EVACO, and ethylene alkyl acrylate carbon monoxide; from 5 to 50 wt % of a flame retardant agent; and from 15 to 70 wt % of a filler; based on the total weight of the composition.

The application claims priority to U.S. Provisional Application No. 60/682,288, filed May 18, 2005 and the entire disclosure of which is incorporated herein by reference.

The invention relates to flame retardant compositions, to sheets made of such compositions, and to multilayer structures including such sheets which can be used in building applications.

### BACKGROUND OF THE INVENTION

For panels used in building and construction applications, flame retardant materials are desirable to protect against the spread of fire. Flame retardant panels cover the external surface of buildings and usually have a “sandwich” structure, the two external layers being made of metal and the intermediate layer of a flame retardant composition as described in the next paragraph below.

Important characteristics for flame retardant compositions for building panels are high flame retardancy, good heat performance and good mechanical properties. Such compositions must have a Limited Oxygen Index (LOI) of at least 29, measured according to ASTM D2863, in order to have the required flame retardancy features. Today, typical flame retardant compositions suitable for the manufacture of building panels are based on blends of polyethylene (PE) and/or ethylene vinyl acetate (EVA) with up to about 70 wt % of a flame retardant agent such as aluminum trihydrate (ATH). Optionally, such compositions include up to about 7 wt % of a modified polymer such as PE and/or EVA grafted with maleic anhydride. On the other hand, there is also a general desire in building applications to be cost efficient. Flame retardant agents such as ATH are expensive so that typical flame retardant compositions which include high amounts of these compounds may become expensive.

The problem at the root of the present invention is therefore to provide low cost flame retardant compositions for the manufacture of building panels, which compositions have an LOI of at least 29 or more measured according to ASTM D2863.

### SUMMARY OF THE INVENTION

A flame retardant composition that can be used for manufacturing building panels comprising

(a) from 15 to 50 wt % of one or more ethylene copolymers chosen among EVA, ethylene alkyl acrylate, ethylene vinyl acetate carbon monoxide (EVACO) and ethylene alkyl acrylate carbon monoxide;

(b) from 5 to 50 wt % of a flame retardant agent; and

(c) from 15 to 70 wt % of an inert filler;

the weight percentages being based on the total weight of the composition.

The invention also provides a sheet for building panels made with the above flame retardant composition.

The invention further provides a multilayer structure for building panels comprising at least one sheet as described above, which sheet is positioned between two external layers made of aluminum.

### DETAILED DESCRIPTION OF THE INVENTION

The EVA copolymer used in the composition may contain from 25 to 90 wt % of ethylene and 10 to 75 wt % of vinyl acetate, or from 55 to 75 wt % of ethylene and 20 to 45 wt % of vinyl acetate, the weight percentages being based on the total amount of the EVA copolymer. Generally, the EVA copolymer of the composition has a melt flow index (MFI) in the range between 0.05 and 100 g/10 min, or less than 50 g/10 min, measured according to ASTM D-1238 (2.16 kg and 190° C.).

The ethylene alkyl acrylate copolymer used in the composition according to the present invention may contain from 25 to 90 wt % of ethylene and 10 to 75 wt % of alkyl acrylate, or from 55 to 75 wt % of ethylene and 15 to 45 wt % of alkyl acrylate, the weight percentages being based on the total amount of the ethylene alkyl acrylate copolymer. The ethylene alkyl acrylate copolymer may have an MFI in the range of between 0.05 and 100 g/10 min, or 15 to 60 g/10 min, measured according to ASTM D-1238 (2.16 kg and 190° C.). The ethylene alkyl acrylate copolymer can be one or more of ethylene methyl acrylate, ethylene ethyl acrylate and ethylene butyl acrylate.

The EVACO copolymer used in the composition according to the present invention may contain from 30 to 90 wt % of ethylene, from 10 to 70 wt % of vinyl acetate and 1 to 20 wt % of carbon monoxide, or from 55 to 65 wt % of ethylene, 20 to 30 wt % of vinylacetate and 5 to 15 wt % of carbon monoxide, the weight percentages being based on the total amount of the EVACO copolymer. Generally the EVACO copolymer of the composition has a melt flow index (MFI) in the range between 1 and 50 g/10 min, or between 10 and 40 g/10 min, measured according to ASTM D-1238 (2.16 kg and 190° C.).

The ethylene alkyl acrylate carbon monoxide copolymer used in the composition according to the present invention may contain from 30 to 90 wt % of ethylene, 10 to 70 wt % of alkyl acrylate and 1 to 20 wt % of carbon monoxide, or from 55 to 65 wt % of ethylene, 20 to 30 wt % of alkyl acrylate and 5 to 15 wt % of carbon monoxide, the weight percentages being based on the total amount of the ethylene alkyl acrylate carbon monoxide copolymer. Generally the ethylene alkyl acrylate carbon monoxide copolymer of the composition may have an MFI in the range between 1 and 50 g/10 min, or between 10 and 40 g/10 min, measured according to ASTM D-1238 (2.16 kg and 190° C.). The ethylene alkyl acrylate carbon monoxide copolymer can be one or more of ethylene methyl acrylate carbon monoxide (EMACO), ethylene ethyl acrylate carbon monoxide (EEACO) and ethylene butyl acrylate carbon monoxide (EBACO).

According to an embodiment of the invention, the ethylene copolymer can be present in the composition from 20 to 30 wt %, or about 25 wt %, of the total weight of the composition.

According to another embodiment of the present invention, the one or more ethylene copolymers are grafted and/or copolymerized with 0.2 to 3 wt % of a carboxylic acid or a carboxylic acid anhydride functionality, the weight percentages being based on the total weight of the one or more ethylene copolymers. Such carboxylic acid or carboxylic acid anhydride functionality improves the elongation at break of the flame retardant composition itself and also improves the adhesion of the composition to metal surfaces such as aluminum.

The flame retardant agent used in the composition according to the present invention can be any flame retardant agent known in the art. Typically, the flame retardant agent is one or more of ATH and magnesium trihydrate. It may be present from 10 to 30 wt %, or about 20 wt %, of the total weight of the flame retardant composition.

The inert filler used in the composition according to the present invention can be any inert filler known in the art. The inert filler can be one or more of calcium carbonate, talcum, calcinated clay, mica and zinc borate. The inert filler can be present in an amount from 40 to 65 wt %, or about 55 wt %, of the total weight of the flame retardant composition.

In addition to the components described above, the flame retardant composition can be blended with common additives such as antioxidants, UV stabilizers, lubricants (e.g. oleamide), antiblocking agents, antistatic agents, waxes, pigments, titanium dioxide and other processing aids (e.g. zinc stearate) known in the polymer compounding art. These additives may be present in the composition in amounts and in forms well known in the art.

The flame retardant composition can be prepared by mixing the ingredients described above by use of conventional masticating equipments, for example, a rubber mill, Brabender Mixer, Banbury Mixer, Buss-ko kneader, Farrel continuous mixer or twin screw continuous mixer. Mixing times and processing temperatures can be adjusted to obtain substantially homogeneous blends as well as proper reaction in case grafted polymers are included in the composition. Typically, mixing times of about one (1) to five (5) minutes and mixing temperatures of 160° C. are satisfactory.

The flame retardant composition comprising the inert filler may reduce the overall cost of the composition and, therefore, the overall manufacturing costs of the final building panels. Furthermore, the partial replacement of the flame retardant agent by inert filler does not affect, but may improve, the flame retardancy properties of the composition itself.

Sheets made with the flame retardant composition described above are also an object of the present invention. Such sheets may have a thickness varying between 0.01 and 15 mm or 1 and 10 mm and can be manufactured either directly by melt blend extrusion as described above, or alternatively by preparing the flame retardant composition which is subsequently processed by means of any conventional technology such as extrusion, calendering and hot lamination.

A multilayer structure may comprise at least one sheet of the above flame retardant composition, which sheet is adjacent to at least one aluminum layer, and may be positioned between two external aluminum layers. The function of the at least one aluminum layer, or the two (e.g., external) aluminum layers, is to confer to the sheet structure itself strength, stiffness, resistance to various weather conditions, additional flame retardancy and aesthetical appearance. The multilayer structure according to the present invention is used as outer layer on building walls whereby the at least one aluminum layer is visible.

The one or more aluminum layers may have a thickness varying from 200 μm to 2 mm, 300 μm to 1 mm, or about 500 μm.

The multilayer structure described above can be manufactured by conventional methods. These methods include extrusion coating the flame retardant composition onto aluminum sheets and extrusion laminating the flame retardant composition between aluminum sheets. If necessary, a layer of a conventional adhesive is applied onto the aluminum sheet prior to the extrusion or lamination process.

The invention will be further described in the following Examples.

### EXAMPLES

General Procedure

Blends were prepared by melt-compounding the components in the amounts given in the following examples. The melt compounding was carried out on a two roll mill with batches from 100 grams at 150-170° C. for about five minutes. The milled product was formed into a testing plaque in a hydraulic press at 150-170° C. for about five minutes. Afterward the Limited Oxygen Index (LOI, ASTM D2863), the tensile strength (ASTM D638) and the elongation at break (ASTM D638) were tested. The results are shown in Table 1.

### Example 1

20 g of ethylene methyl acrylate from E.I. du Pont de Nemours and Company (DuPont) as Elvaloy®AC 1609.

20 g of ATH from Alcan Chemicals Europe under the tradename Baco SF7.

60 grams of calcium carbonate from Alpha Calcit Füllstoff GmbH. & Co. KG under the tradename Calcicoll W 15.

### Example 2

25 g of ethylene methyl acrylate as in Example 1.

20 g of ATH as in Example 1.

55 g of calcium carbonate as in Example 1.

### Example 3

20 g of ethylene methyl acrylate from DuPont as Elvaloy® AC 12024.

20 g of ATH as in Example 1.

60 grams of calcium carbonate as in Example 1.

### Example 4

2 g of ethylene methyl acrylate grafted with maleic anhydride (MAH) from DuPont as Fusabond® 556D.

18 g of ethylene methyl acrylate as in Example 3.

20 g of ATH as in Example 1.

60 g of calcium carbonate as in Example 1.

### Example 5

20 g of ethylene methyl acrylate from DuPont under the tradename Elvaloy® AC 1820.

20 g of ATH as in Example 1.

60 g of calcium carbonate as in Example 1.

### Example 6 (Comparative)

31.5 g of polyethylene having a density of about 0.920 g/cm³ measured according to ASTM 7920.

68.5 g of ATH as in Example 1.

### Example 7 (Comparative)

30 g of ethylene methyl acrylate from DuPont as Elvaloy® AC 1820.

70 g as in Example 1.

### Example 8 (Comparative)

20 g of ethylene methyl acrylate as in Example 7.

80 g as in Example 1.

TABLE 1

| | Ex No. | | | | | | | |
|---|---|---|---|---|---|---|---|---|
| | 1 | 2 | 3 | 4 | 5 | 6 | 7 | 8 |
| LOI (%) | 36 | 32 | n.m⁽³⁾ | 33 | 33 | 29 | 22 | 27 |
| TS⁽¹⁾ (MPa) | 9.9 | 10 | 5.6 | 6.9 | n.m⁽³⁾ | 4.6 | n.m⁽³⁾ | n.m⁽³⁾ |
| EB⁽²⁾ (%) | 12 | 15 | 17 | 21 | n.m⁽³⁾ | 21 | n.m⁽³⁾ | n.m⁽³⁾ |

⁽¹⁾Tensile Strength
⁽²⁾Elongation at Break
⁽³⁾not measured

Table 1 shows that compositions of the invention (Examples 1 to 5) had higher LOI values than compositions of comparative Examples 6 to 8. Therefore, the compositions of the invention are not only less expensive but also perform better than conventional ones, such as blends of polyethylene and ATH (Example 6). The mechanical properties Examples 1-5 were almost better than those of conventional compositions whereby it could be noted that the presence of grafted ethylene copolymers increased the elongation at break of the composition (Example 4).

1. A composition comprising
(a) from 15 to 50 wt % of one or more ethylene copolymers comprising ethylene vinyl acetate copolymer, ethylene alkyl acrylate copolymer, ethylene vinyl acetate carbon monoxide copolymer, and ethylene alkyl acrylate carbon monoxide copolymer, or combinations of two or more thereof;
(b) from 5 to 50 wt % of a flame retardant agent; and
(c) from 15 to 70 wt % of an inert filler;
the weight percentages being based on the total weight of the composition.

2. The composition of claim 1 wherein the ethylene alkyl acrylate copolymer is one or more of ethylene methyl acrylate copolymer, ethylene ethyl acrylate copolymer, ethylene butyl acrylate copolymer, or combinations of two or more thereof.

3. The composition of claim 1 wherein the ethylene alkyl acrylate carbon monoxide copolymer is one or more of ethylene methyl acrylate carbon monoxide copolymer, ethylene ethyl acrylate carbon monoxide copolymer, ethylene butyl acrylate carbon monoxide copolymer, or combinations of two or more thereof.

4. The composition of claim 3 wherein the ethylene alkyl acrylate copolymer is one or more of ethylene methyl acrylate copolymer, ethylene ethyl acrylate copolymer, ethylene butyl acrylate copolymer, or combinations of two or more thereof.

5. The composition of claim 1 wherein the agent is one or more of aluminum trihydrate, magnesium trihydrate, or combinations thereof.

6. The composition of claim 4 wherein the agent is one or more of aluminum trihydrate, magnesium trihydrate, or combinations thereof.

7. The composition of claim 1 wherein the filler is one or more of calcium carbonate, talcum, calcinated clay, mica, zinc borate, or combinations of two or more thereof.

8. The composition of claim 2 wherein the filler is one or more of calcium carbonate, talcum, calcinated clay, mica, zinc borate, or combinations of two or more thereof.

9. The composition of claim 6 wherein the filler is one or more of calcium carbonate, talcum, calcinated clay, mica, zinc borate, or combinations of two or more thereof.

10. The composition of claim 1 wherein the ethylene copolymer is present from 20 to 30 wt %, the agent is optionally present from 10 to 30 wt %, and the filler is present from 40 to 65 wt %, all based on the total weight of the composition.

11. The composition of claim 9 wherein the ethylene copolymer is present from 20 to 30 wt %, the agent is optionally present from 10 to 30 wt %, and the filler is present from 40 to 65 wt %, all based on the total weight of the composition.

12. The composition of claim 1 wherein the ethylene copolymer is grafted, copolymerized, or grafted and copolymerized, with 0.2 to 3 wt % of a carboxylic acid or carboxylic acid anhydride, based on the total weight of the ethylene copolymer.

13. The composition of claim 6 wherein the ethylene copolymer is grafted, copolymerized, or grafted and copolymerized, with 0.2 to 3 wt % of a carboxylic acid or carboxylic acid anhydride, based on the total weight of the ethylene copolymer.

14. The composition of claim 11 wherein the ethylene copolymer is grafted, copolymerized, or grafted and copolymerized, with 0.2 to 3 wt % of a carboxylic acid or carboxylic acid anhydride, based on the total weight of the ethylene copolymer.

15. The composition of claim 1 comprising about 25 wt % of ethylene methyl acrylate copolymer, about 20 wt % of aluminum trihydrate; and about 55 wt % of calcium carbonate.

16. A sheet for building panels comprising or made with a composition wherein the sheet optionally has a thickness between 1 and 10 mm and the composition is as recited in claim 1.

17. The sheet of claim 16 wherein the composition is as recited in claim 3.

18. The sheet of claim 16 wherein the composition is as recited in claim 6.

19. The sheet of claim 16 wherein the sheet has a thickness from 1 to 10 mm and the composition is as recited in claim 11.

20. The sheet of claim 19 wherein the sheet is positioned between two layers of aluminum, the composition is as recited in claim 14, and the two layers are optionally external layers.
